(19) United States
(12) Patent Application Publication
(10) Pub. No.: US 2026/0302611 A1
(43) Pub. Date: Oct. 1, 2026

(54) BEAMFORMING AND CONTROL FOR PHASED ARRAY ANTENNA MODULE (PAAM)

(71) Applicant: KYOCERA CORPORATION, Kyoto (JP)

(72) Inventors: James Wang, San Diego, CA (US); Mike Yang, San Diego, CA (US)

(73) Assignee: KYOCERA CORPORATION, Kyoto (JP)

(21) Appl. No.: 19/699,538

(22) Filed: Jun. 5, 2026

Related U.S. Application Data
(63) Continuation of application No. PCT/US24/58916, filed on Dec. 6, 2024.
(60) Provisional application No. 63/607,210, filed on Dec. 7, 2023.

(30) Foreign Application Priority Data
Dec. 6, 2024 (WO) PCT/US24/58916

(51) Int. Cl. H01Q 3/28; H01Q 3/36; H04B 7/08

(52) U.S. Cl. CPC H01Q 3/28; H01Q 3/36; H04B 7/088

(57) ABSTRACT

Method and system are provided for reducing the AWV table size for phased array-antenna. In one novel aspect, primitive AWV and beam steering AWV are generated and stored for phased-array antenna module. In one embodiment, the phased-array antenna system obtains a primitive AWV table, wherein each primitive beam is selected from a group of beams with similar beam properties, obtains a beam steering AWV table with a set of steering vectors for a set of beams, wherein a set of beam composite AWVs for the set of beams are derived by applying corresponding steering vector in the beam steering AWV table to a primitive composite AWV in the primitive AWV table, and stores the primitive AWV table and the beam steering AWV table in the PAAM. In one embodiment, the primitive AWV table and the beam steering AWV table are generated based on one more criteria to minimize distortion.

### CROSS REFERENCE TO RELATED APPLICATIONS

This application is filed under 35 U.S.C. § 111 (a) and is based on and hereby claims priority under 35 U.S.C. § 120 and § 365 (c) from International Application No. PCT/US24/58916, titled “BEAMFORMING AND CONTROL FOR PHASED ARRAY ANTENNA MODULE (PAAM),”, filed Dec. 6, 2024. Application PCT/US24/58916, in turn, claims the benefit under 35 U.S.C. § 119 from U.S. provisional application Ser. No. 63/607,210, entitled “BEAMFORMING AND CONTROL FOR PHASED ARRAY ANTENNA MODULE (PAAM),” filed on Dec. 7, 2023, the subject matter of which is incorporated herein by reference.

### TECHNICAL FIELD

The disclosed embodiments relate generally to phased-array antennas, and, more particularly, to beamforming and control for phased array antenna module (PAAM).

### BACKGROUND

Phased-array antennas represent a sophisticated and versatile class of antenna systems that have gained prominence in various applications, ranging from radar and communication systems to satellite and wireless networks. Phased-array antennas offer several advantages, including high-speed beam agility, improved signal quality, and the ability to handle multiple tasks simultaneously. Unlike traditional antennas that rely on mechanical steering for beam direction, phased-array antennas achieve beam control through electronic means, providing rapid and precise adjustments. At the core of a phased-array antenna are multiple individual antenna elements, each connected to a phase shifter. By manipulating the phase and amplitude of the signals applied to these elements, the antenna system can shape and steer the emitted or received electromagnetic waves. This electronic beam steering capability enhances agility, responsiveness, and enables functionalities such as beamforming, beam scanning, and nulling interference.

Antenna Weight Vector (AWV) Tables play a crucial role in the operation and optimization of phased-array antennas. In practice, each antenna has a corresponding AWV table. The size of the AWV table affects the size of the integrated circuit (IC).

Enhancement and improvement are needed to reduce the size of the AWV tables for the phased-array antennas.

### SUMMARY

Method and system are provided for reducing the AWV table size for phased-array antenna. In one novel aspect, primitive AWV and beams steering AWV are generated and stored for phased-array antenna module. In one embodiment, the system obtains a primitive AWV table, wherein the primitive AWV table includes one or more primitive composite AWVs of one or more corresponding primitive beams, and wherein each primitive beam is selected from a group of beams with similar beam properties, obtains a beam steering AWV table with a set of steering vectors for a set of beams, wherein a set of beam composite AWVs for the set of beams are derived by applying corresponding steering vector in the beam steering AWV table to a primitive composite AWV in the primitive AWV table, and stores the primitive AWV table and the beam steering AWV table in the phased-array antenna module (PAAM). In one embodiment, the primitive AWV table and the beam steering AWV table are generated by grouping the set of beams into different groups based on beam properties comprising a beam strength, a beam shape, and a beam sidelobe. In another embodiment, the primitive AWV table and the beam steering AWV table are generated based on one or more criteria comprising: a primitive beam is selected such that a derived beam is generated based on the primitive beam and a corresponding steering vector to retain similar beam properties, a steering vector is selected such that a derived beam is generated with a predefined minimum distortion. In yet another embodiment, steering vectors of the beam steering AWV table are used in intrinsic beam or spoiled beam. In one embodiment, a steering factor for an antenna element (nₓ, n_{y}) at position (nₓ*dₓ, n_{y}*d_{y}) of the antenna array comprising linear incremental phase shift to steer a beam in x and y direction nₓΔₓ+n_{y}Δ_{y} and an amplitude tapering factor attenuation_{nx,ny}. A set of steering factors to be applied to each antenna element forms a steering vector defining a derived beam steering AWV. In one embodiment, the system assigns a beam index to each beam composite AWV. The beam index has multiple N bits, and wherein N1 bits are assigned to indicate a primitive AWV and N2 bits are assigned to indicate a steering beam AWV, and wherein N1 and N2 are greater than or equal to one and N1+N2 is smaller than or equal to N. In one embodiment, one or more beam identifiers (IDs) assigned to one or more application beams within a codebook for an application are mapped to a subset of beam indexes of the set of beams.

In one novel aspect, beam switching process is provided using primitive AWV and beam steering AWV. In one embodiment, the system sends a beam control message ahead of a starting symbol, wherein the beam control message includes a beam ID, a starting symbol time within a frame for the beam switching, and a number of symbols for beam dwelling, sends or receives a data message ahead of the starting symbol, wherein the data message includes samples of a signal, a starting symbol time, and a number of symbols within a frame of a signal, retrieves the beam ID from the beam control message, and forwards the beam ID to a controller for the beam switching based on the starting symbol time the number of symbols for beam dwelling.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary phased-array antenna system with reduced sized AWV tables in accordance with embodiments of the current invention.

FIG. 2 illustrates exemplary diagrams for generating/obtaining primitive AWV and beam steering AWV in accordance with embodiments of the current invention.

FIG. 3A illustrates exemplary diagrams for beam ID, beam index, and antenna codebook with primitive and beam steering AWVs for beam switch control in accordance with embodiments of the current invention.

FIG. 3B illustrates exemplary diagrams for primitive AWV and offset steering vector in accordance with embodiments of the current invention.

FIG. 4 illustrates exemplary diagrams for beam switching control procedures based on a primitive AWV table and a steering AWV table in accordance with embodiments of the current invention.

FIG. 5 illustrates an exemplary flow chart for the obtaining and storing primitive AWV and beam steering AWV in accordance with embodiments of the current invention.

FIG. 6 illustrates an exemplary flow chart for beam switch control with AWV in accordance with embodiments of the current invention.

### DETAILED DESCRIPTION

Reference will now be made in detail to some embodiments of the invention, examples of which are illustrated in the accompanying drawings.

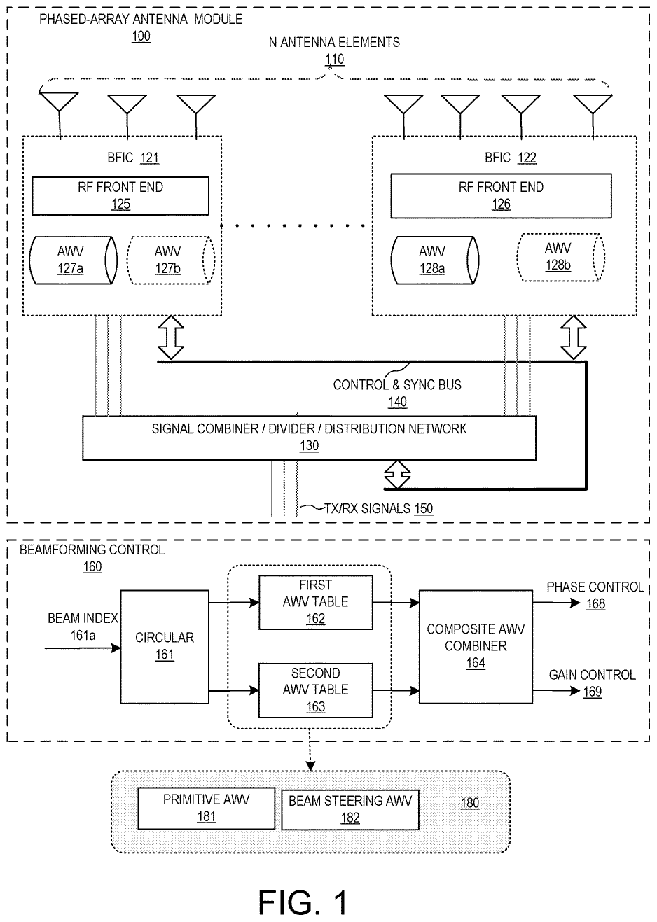

FIG. 1 illustrates an exemplary phased-array antenna system with reduced sized AWV tables in accordance with embodiments of the current invention. Phased-array antenna 100 has N antenna elements 110 each served by corresponding beamforming integrated circuit, such as BFIC 121, 122. Each BFIC has an RF Front End, such as RF front end 126 for BFIC 121 and RF front end 126 for BFIC 122. Each RF Front End has one or more RF chains where each RF chain serves one polarization of one antenna element connected to the BFIC. For an FDD (Frequency Division Duplexing) Phased-Array, a transmit RF chain typically consists of power amplifier (PA) and Phase-Shifter for Transmit Array and low noise amplifier (LNA) and Phase Shifter for Receive Array. For TDD (Time-Division Duplexing) array, RF chain consists of antenna switch, PA, TX phase Shifter, LNA and RX Phase shifter. The PAAM 100 includes at least one BFIC and combiner/divider circuit network 130. The BFIC stores one or more antenna weight vector (AWV) tables, such as AWV 127a, 127b, 128a, and 128b. In one embodiment, each composite AWV derived from a combination of a primitive AWV and a beam steering AWV. In one embodiment, the phased-array antenna module 100 also includes signal combiner/divider/distribution network 130 and control and synchronization bus 140. PAAM 100 performs signal transmission and reception (150) through signal combiner/divider/distribution network 130. AWV tables are stored for each antenna element in PAAM 100.

In one novel aspect Beamforming control process 160 is illustrated. The beam switching process stores beam IDs in a circular buffer (161). The control process receives beam index 161a. A beam index table stores beam indexes corresponding to beam IDs. Each beam index indicates a first entry in a first AWV table 162 and a second entry in a second AWV table 163. Composite AWV combiner 164 generates the composite AWV for the beam. The AWV controls the phase shifter for phase control process 168, Phase (Combiner AWV)=(Phase (AWV_{Primitive AWV})+Phase (AWV_{steering AWV})) Modulo 360 (degree). The phase shifters steer the beam directions. As an example, nominal phase shift step is 2.875-degree with the range of 0-360 degrees. In one embodiment, the target phase accuracy is 1 phase step. The AWV also controls the gain setting with the gain control process 169, ATT (Combiner AWV)=min {[ATT (AWV_{Primitive AWV})+ATT (AWV_{Steering AWV})], ATTₘₐₓ} (dB), ATTₘₐₓ is the maximum attenuation value. The gain setting process performs amplitude tapering and beam shaping/synthesis. The nominal gain step is 0.375 db and range is greater than 30 dB. An AWV has phase/gain settings for all antenna elements 110 in PAAM 100. An AWV corresponding to the settings for all the BFICs, such as BFIC 121, 122, in the PAAM 100 for forming an antenna beam, determining the beam direction and beam characteristic/properties, such as beam width/gain and shape. In one embodiment, the beam properties include a beam strength, a beam shape, and a beam sidelobe. In one embodiment, PAAM stores each beam ID in circular buffer 161, wherein the circular buffer includes a plurality of entries, each configured to store a beam ID and advances to a next beam ID in the circular buffer in response to the beam switching pulse.

The AWV for PAAM is programmable. It allows different patterns (one pattern per AWV) to be performed. The AWV can include any correction values from the antenna calibration performed in the chamber. However, AWVs to be used in the real time operation need to be pre-stored within the on-chip storage table in PAAM. The bus speed does not support AWV being updated in real time operation. The digital noise from active digital bus activities should be avoided to prevent coupling into signal. AWV storage table is embedded in each BFIC within PAAM. AWV storage table can store multiple AWVs. Each AWV consists of specific gain and phase settings for all RF chains, each RF chain connects to a selected polarization of an antenna element. Each antenna polarization ‘0’ and antenna polarization ‘1’ has its own AWV. Thus, different antenna patterns can be formed for antenna polarization ‘0’ and polarization ‘1’. Beam index table 161 includes pointers of beam indexes. A beam index in beam index table 161 corresponding to a beam ID indicates the active AWV with the AWV storage table being used/active. In one embodiment, the mapping between Beam ID and Beam Index can be done at RU. In an application, the beam Indexes mapped to the Beam IDs are a subset of total Stored Beam Indexes available. In one embodiment, the AWV tables includes a primitive AWV 181 and a beam steering AWV 182. In one example, primitive AWV table 181 stores up to 60 primitive AWVs and beam steering AWV table 182 stores up to 16 steering AWVs. Primitive AWVs and steering AWV from the two tables can be combined to form a “composite AWV”. Combiner 164 performs an operation where two phase shift values from the two tables are added and the gain attenuation or tapering (in dB) are added. Here an AWV for an antenna pattern is a composite AWV. In one embodiment, a different set of AWV tables 180 is generated with a primitive AWV 181 with a set of composite AWVs corresponding to a group of primitive beams, each selected from a group of beams with similar beam properties. Beam steering AWV table 182 includes a set of steering vectors wherein a set of beam composite AWVs for a set of beams are derived by applying corresponding steering vector in the beam steering AWV table to a primitive composite AWV in the primitive AWV table.

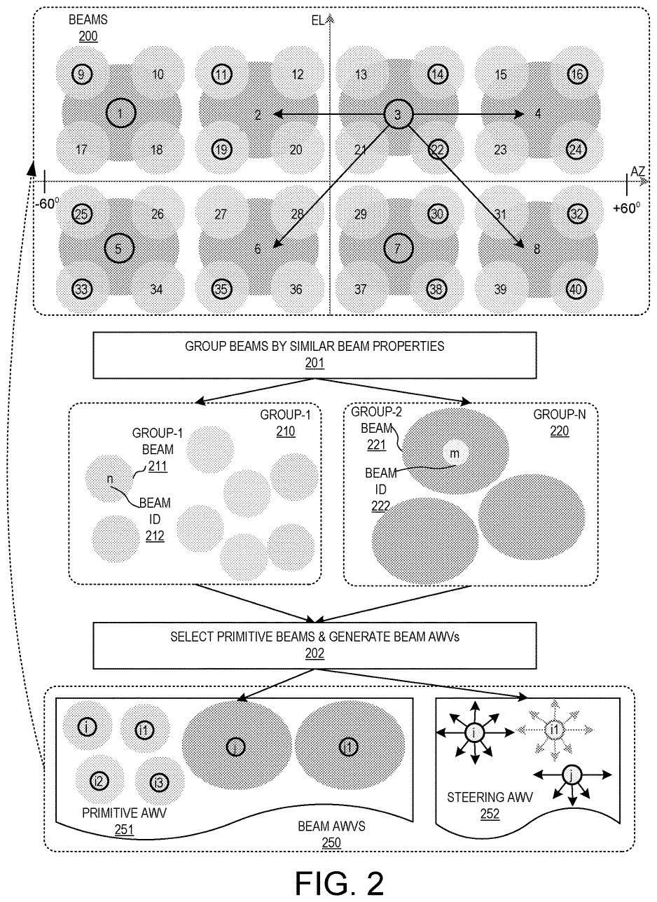

FIG. 2 illustrates exemplary diagrams for generating/obtaining primitive AWV and beam steering AWV in accordance with embodiments of the current invention. An exemplary set of beams 200 includes beams of different beam properties, and each is associated with a beam ID, such as beams with beam IDs of 1-40, exemplary represented in the EL/AZ coordinates. In one embodiment, at step 201, beams 200 are grouped by similar beam properties. In one example, beams 200 are grouped into group-1 210 and group-N 220. Group-1 beam 211 has a beam ID 212 of n. Group-N beam 221 has a beam ID 222 of m. At step 202, beam AWVs 250 are obtained by selecting primitive beams and generating primitive AWVs 251 and corresponding steering AWVs 252. A group of primitive beams are selected from each beam group, such as beam group-1 210 and beam group-N 220. The set of beams 251, as bold circled in beams 200 are selected/generated based on one or more criteria comprising: a primitive beam is selected such that a derived beam is generated based on the primitive beam and a corresponding steering vector to retain similar beam properties, a steering vector is selected such that a derived beam is generated with a predefined minimum distortion, a primitive beam is selected. The composite AWVs of the selected primitive beams are stored in the first AWV table. In one embodiment, the first AWV table uses the primitive AWV table. In one embodiment, the primitive AWVs are generally derived from chamber calibration. When a primitive AWV is stored in the primitive AWV Table, the corresponding steering AWV is a null AWV (zero phase shift and gain attenuation). The composite AWV from the primitive AWV and the null AWV (steering AWV) are the same as the primitive AWV. For example, for beams 200, beams of beam IDs #1, #3, and #5 are selected as the primitive beams from group-N 220, which have similar beam properties. Beams with beam ID #9, #11, #14, #16, #19, #22, #24, #25, #30, #32, #33, #35, #38, and #40 are selected from group-1 210 with similar beam properties. The rest of the beams in beam 200 can be derived by “beam steering” the primitive AWV using beam steering AWV in beam steering AWV table 252. For example, beams with beam ID #10 and #18 can be derived from primitive beam with beam ID #9. Beams with beam ID #2, #4, #6 and #8 can be derived from primitive beam with beam ID #3. In one embodiment, the primitive beam AWV 251 is stored within the primitive AWV table. In one embodiment, the beam steering AWV 252 can be stored within the steering AWV table.

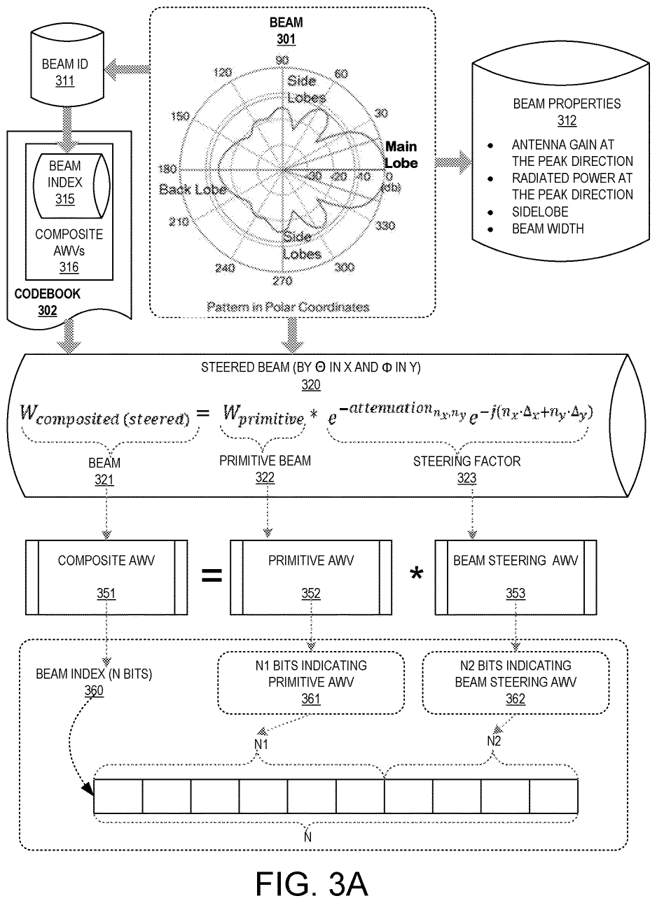

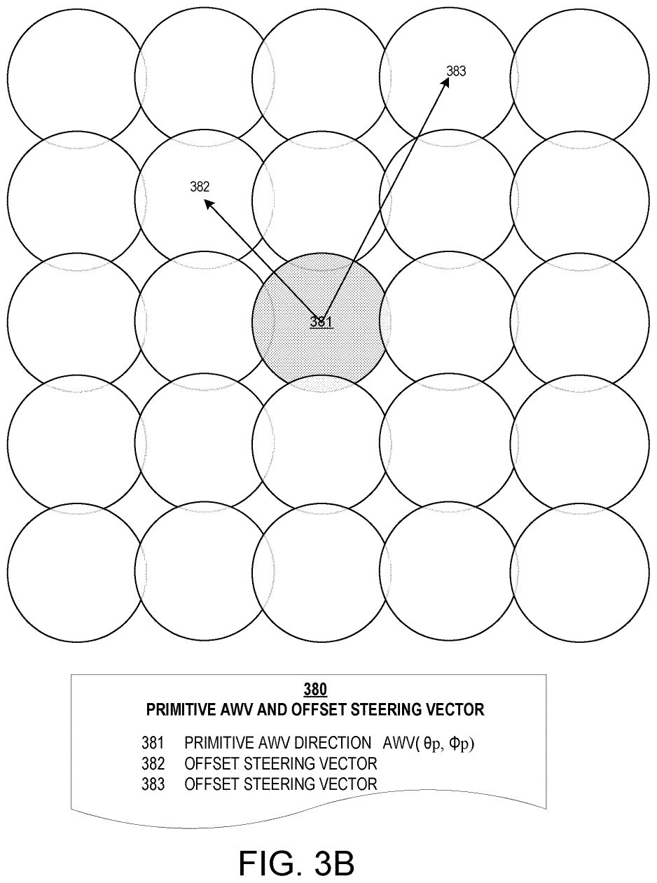

FIG. 3A illustrates exemplary diagrams for beam ID, beam index, antenna codebook with primitive and beam steering AWVs for beam switch control in accordance with embodiments of the current invention. An exemplary beam 301 is assigned/associated with beam ID 311. Each beam, such as beam 301, has a set of beam properties 312, such as antenna gain at the peak direction, radiated power at the peak direction, sidelobe, which may cause interference to adjacent cells or users in the off-peak direction, and beam width, which determines how wide the coverage angel of the beam. In one embodiment, the beam properties comprise a beam strength, a beam shape, and a beam sidelobe. Antenna codebook 302 includes selected composite AWVs 316, which corresponding to antenna patterns, to be used in an application. In one example, it is possible to generate nine hundred and sixty beams with composite AWVs. A beam index 315 is assigned to each composite AWV. The Beam IDs assigned to the beams within the codebook in an application are mapped to a subset of the beam indexes.

Exemplary codebook 302 includes a selected set of AWVs for an application. To steer a beam by θ in the x (azimuth) direction φ in the y (elevation) direction, steered beam 320 is generated/obtained for beam switching. Steered beam has a composite weight 321

$${W}_{composited ( steered )} .$$

Steered beam composite weight 321 is derived from a primitive composite AWV Wₚᵣᵢₘᵢₜᵢᵥₑ 322 steered with steering factor 323

$${e}^{- {attenuation}_{{n}_{x} , {n}_{y}}} {e}^{- j ( {n}_{x} \cdot {Δ}_{x} + {n}_{y} \cdot {Δ}_{y} )}$$

by

$${W}_{composited ( steered )} = {W}_{primitive} * {e}^{- {attenuation}_{{n}_{x} , {n}_{y}}} {e}^{- j ( {n}_{x} \cdot {Δ}_{x} + {n}_{y} \cdot {Δ}_{y} )}$$

(nₓ, n_{y}) is the antenna position within the array, nₓΔₓ, n_{y}Δ_{y} is the linear incremental phase shift in x and y directions to steer the beam, and

$${e}^{- {attenuation}_{{n}_{x} , {n}_{y}}}$$

is the amplitude tapering (attenuation). In a typical realization, the gain attenuation or tapering (in dB) in the steering AWV can be set to 0 dB (i.e. no gain attenuation). In a more generalized implementation, the gain attenuation or tapering (in dB) in the steering AWV can be set to a value other than 0 dB. If the steering AWV performs only beam direction steering (with altering beam shape), it is expressed as

$${e}^{- j {\underline{d}}_{m , n}^{T} \cdot Δ \underline{a} ( θ , φ )}$$

where Δa(θ,φ) represents the offset wave vector between the beam direction of the corresponding primitive AWV as represented by a wave vector aₚ(θ,φ) and desired beam direction to steer to as represented by the wave vector a(θ,φ). For the sake of convenience, we call it the steering AWV instead of “offset” steering AWV. For clarity, the steering AWV steers the incremental angle direction away from the direction of the primitive AWV. Composite AWV 351 equals primitive AWV 352*beam steering AWV 353.

In one embodiment, the steering vector with the steering factors for all antenna elements is stored in the steering AWV table. Beam steering vectors can be used in both intrinsic beams and spoiled beams. In another embodiment, a null steering vector

$$( {Δ}_{x} = 0 , {Δ}_{y} = 0 , {attenuation}_{{n}_{x} , {n}_{y}} = 0 )$$

is used to maintain the composite AWV for a primitive AWV.

Beam index 360 with N bits is assigned to each composite AWV. In one embodiment, primitive AWV and beam steering AWV are used for the beam switching process. N1 bits of the N-bit beam index is used to indicate the primitive AWV and N2 bits of the N-bit beam index is used to indicate the beam steering AWV. N=N1+N2. In one example, the beam index is 10-bit. Six bits are assigned to indicate the primitive AWV and four bits are assigned to indicate the beam steering AWV. The Beam IDs assigned to the beams within the codebook in an application are mapped to a subset of the Beam Indexes.

FIG. 3B illustrates exemplary diagrams for primitive AWV and offset steering vector in accordance with embodiments of the current invention. In an actual implementation of a phased-array antenna, the signal experiences different delay before reaching the antenna elements within the array. Such delay in the signal or local oscillator (LO) is due to different lengths of the signal routing in the hardware and/or parasitic. Note that extra compensation for such delay experienced by both the signal and LO needs to be added to antenna weight vector. As an illustration, the transmit signal can be

$$transmit signal ( {θ}_{p} , {φ}_{p} ) = {\sum }_{m = 0}^{{N}_{v} - 1} {\sum }_{n = 0}^{{N}_{H} - 1} S ( t - {τ}_{m , n} ) * {w}_{m , n} {e}^{j {\underline{d}}_{m , n}^{T} \underline{k} ( {θ}_{p} , {φ}_{p} )}$$

To compensate the hardware delay offset, the

$${w}_{m , n} ( {θ}_{p} , {φ}_{p} ) = {A}_{m , n} * {e}^{j 2 π {τ}_{m , n}} * {e}^{- j {\underline{d}}_{m , n}^{T} \underline{a} ( {θ}_{p} , {φ}_{p} ) - j 2 π ( {nd}_{h} sin {θ}_{p} sin {φ}_{p} + {md}_{v} cos {θ}_{p} ) / λ} = {A}_{m , n} * {e}^{j 2 π {τ}_{m , n}} * e$$

To steer the beam to other direction (θ,φ), the antenna weight w_{m,n} (θ,φ) can be written as

$${w}_{m , n} ( θ , φ ) = {A}_{m , n} * {e}^{j 2 π {τ}_{m , n}} * {e}^{- j {\underline{d}}_{m , n}^{T} \cdot \underline{a} ( θ , φ )} = {w}_{m , n} ( {θ}_{p} , {φ}_{p} ) * {e}^{- j {\underline{d}}_{m , n}^{T} [ \underline{a} ( θ , φ ) - \underline{a} ( {θ}_{p} , {φ}_{p} ) ]} = {w}_{m , n} ( {θ}_{p} , {φ}_{p} ) * {e}^{- j {\underline{d}}_{m , n}^{T} \cdot Δ \underline{a} ( θ , φ )}$$

Note that w_{m,n} (θ,φ) is decomposed to w_{m,n} (θₚ,φₚ) and the offset steering vector

$${e}^{- j {\underline{d}}_{m , n}^{T} \cdot Δ \underline{a} ( θ , φ )} .$$

We can store the first set of (primitive) AWVs, such as 381, w_{m,n} (θₚ_{ᵢ},φₚ_{ᵢ}) for beams in (θₚ_{ᵢ},φₚ_{ᵢ}) direction where i=0, 1, . . . , L. This can include different type of beams, e.g., with different beam widths. This set of AWV must compensate the hardware delay offset. We can store the offset steering vector, such as 382 and 383,

$${e}^{- j {\underline{d}}_{m , n}^{T} \cdot Δ \underline{a} ( θ , φ )}$$

in the second table. Note that the second set of AWV only depends on the angle offset between (θ,φ) and (θₚ_{ᵢ},φₚ_{ᵢ}).

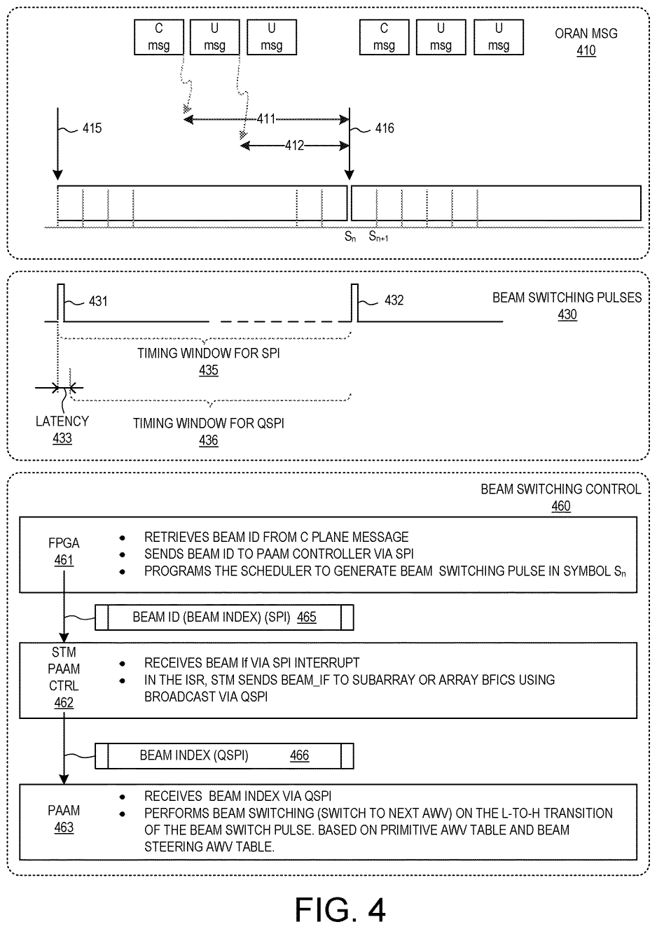

FIG. 4 illustrates exemplary diagrams for beam switching control procedures based on a primitive AWV table and a steering AWV table in accordance with embodiments of the current invention. In a system, to control the beam, a beam control message is required to provide the Beam ID to the PAAM which is then mapped to a Beam Index. The purpose of steering the beam is to transmit data in a particular direction, a data message is required. The system must provide timing information such that the beam is steered to the correct orientation at the correct time. Elements of the timing information may be included in both the beam control message and the data message. An example of these messages would be the Open Radio Access Network (ORAN) where the control plane (C plane) messages can include the beam control message, and the user plane (U plane) that can include the data message. ORAN messages are used to communicate between an ORAN distributed unit (O-DU) and an ORAN RU (O-RU). Exemplary ORAN message 410 includes C plane messages and U plane messages. Exemplary beam switch pulses, such as pulse 431 received at 415, and pulse 432 received at 416. The C plane message carrying beam ID is transmitted ahead of the U plane message carrying IQ samples of the signal in the ORAN fronthaul. The C plane message also carries the symbol time for the beam switching. The beam ID can be transmitted to PAAM control after the prior beam switching is completed but before the next beam switching epoch. Timer T2a_min_cp_dl 411 is carried in c plane message and timer T2a_min_up 412 is carried in u plane message. The beam switching pulse is generated in FPGA corresponding to the beginning of the symbol when beam is switched. If the beam is switched symbol by symbol, stringent timing control is required. The beam switching pulses include exemplary pulse 431 and pulse 432 at symbol Sn. In one embodiment, a beam switching pulse time aligned with a transition of the starting symbol for triggering the beam switch. The time window for serial peripheral interface (SPI) 435 is from the start of pulse 431 to pulse 432. Latency 433 is between SPI and STM. Timing window 436 for quad SPI (QSPI) is the timing window for SPI minus the latency 433.

In one embodiment 460 for beam switching control, FPGA 461 communicates beam ID/beam index using SPI with STM PAAM control 462 (step 465). STM PAAM control 462 communicates beam index with PAAM 463 using QSPI (step 466). FPGA 461 retrieves beam ID from C plane message, sends beam ID to PAAM controller 461 via SPI (465), and programs the scheduler to generate beam switching pulse in symbol Sn. STM PAAM controller 462 receives beam IF via SPI interrupt. In the interrupt service routine (ISR), STM sends BEAM IF to subarray or array BFICs using broadcast QSPI. PAAM 463 receives beam index via QSPI at step 466, and performs beam switching (switch to next AWV) on the L-to-H transition of the beam switch pulse based on a primitive AWV table and a steering AWV table.

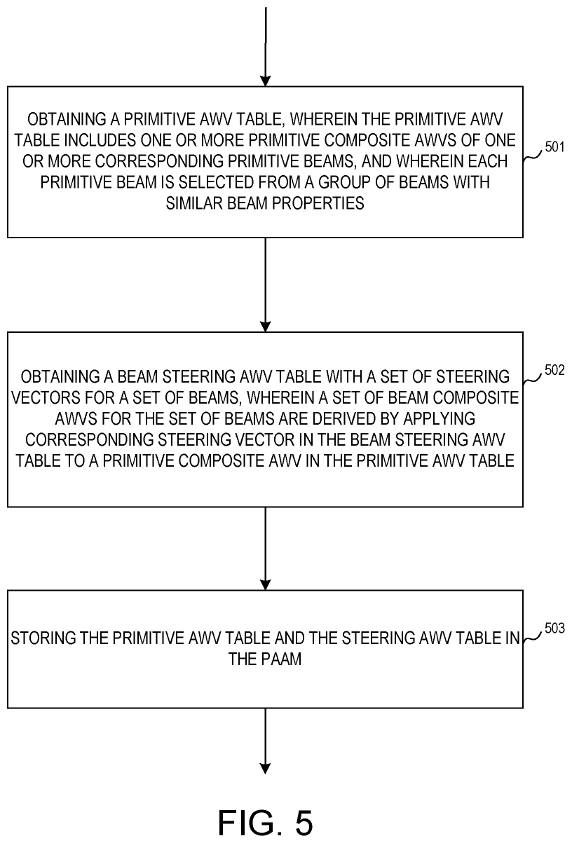

FIG. 5 illustrates an exemplary flow chart for the obtaining and storing primitive AWV and beam steering AWV in accordance with embodiments of the current invention. At step 501, BFIC obtains a primitive AWV table, wherein the primitive AWV table includes one or more primitive composite AWVs of one or more corresponding primitive beams, and wherein each primitive beam is selected from a group of beams with similar beam properties. At step 502, BFIC obtains a beam steering AWV table with a set of steering vectors for a set of beams, wherein a set of beam composite AWVs for the set of beams are derived by applying corresponding steering vector in the beam steering AWV table to a primitive composite AWV in the primitive AWV table. At step 503, BFIC stores the primitive AWV table and the beam steering AWV table in the PAAM.

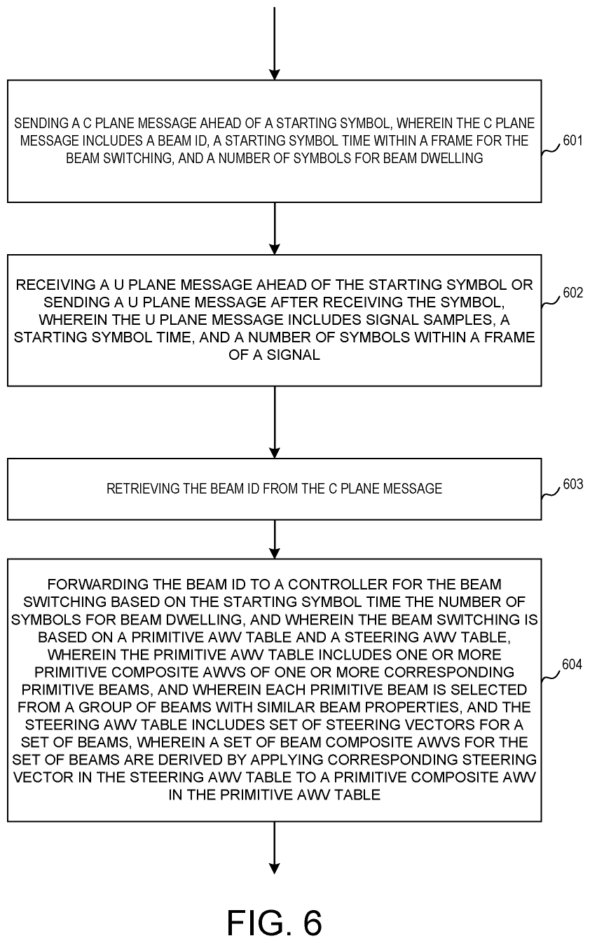

FIG. 6 illustrates an exemplary flow chart for beam switch control with AWV in accordance with embodiments of the current invention. At step 601, the system sends a C plane message ahead of a starting symbol, wherein the C plane message includes a beam ID, a starting symbol time within a frame for the beam switching, and a number of symbols for beam dwelling. At step 602, the system receives a U plane message ahead of the starting symbol or sending a U plane message after receiving the symbol, wherein the U plane message includes signal samples, a starting symbol time, and a number of symbols within a frame of a signal. At step 603, the system retrieves the beam ID from the C plane message. At step 604, the system forwards the beam ID to a controller for the beam switching based on the starting symbol time the number of symbols for beam dwelling, and wherein the beam switching is based on a primitive AWV table and a steering AWV table, wherein the primitive AWV table includes one or more primitive composite AWVs of one or more corresponding primitive beams, and wherein each primitive beam is selected from a group of beams with similar beam properties, and the steering AWV table includes set of steering vectors for a set of beams, wherein a set of beam composite AWVs for the set of beams are derived by applying corresponding steering vector in the steering AWV table to a primitive composite AWV in the primitive AWV table.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, for a phased-array antenna module (PAAM) with multiple antenna elements with antenna weight vector (AWV) tables, comprising:
obtaining a primitive AWV table, wherein the primitive AWV table includes one or more primitive composite AWVs of one or more corresponding primitive beams, and wherein each primitive beam is selected from a group of beams with similar beam properties;
obtaining a beam steering AWV table with a set of steering vectors for a set of beams, wherein a set of beam composite AWVs for the set of beams are derived by applying corresponding steering vector in the beam steering AWV table to a primitive composite AWV in the primitive AWV table; and
storing the primitive AWV table and the beam steering AWV table in the PAAM.

2. The method of claim 1, wherein the primitive AWV table and the beam steering AWV table are generated by grouping the set of beams into different groups based on beam properties comprising a beam strength, a beam shape and a beam sidelobe.

3. The method of claim 1, wherein the primitive AWV table and the beam steering AWV table are generated based on one or more criteria comprising: a primitive beam is selected such that a derived beam is generated based on the primitive beam and a corresponding steering vector to retain similar beam properties, a steering vector is selected such that a derived beam is generated with a predefined minimum distortion.

4. The method of claim 1, wherein steering vectors of the beam steering AWV table are used in intrinsic beam or spoiled beam.

5. The method of claim 1, wherein a steering factor for an antenna element at position (nₓ, n_{y}) of the antenna array comprising linear incremental phase shift to steer a beam in x and y direction nₓΔₓ, n_{y}Δ_{y} and an amplitude tapering factor attenuation_{nx,ny}.

6. The method of claim 1, further comprising: assigning a beam index to each beam composite AWV.

7. The method of claim 6, wherein the beam index has N bits, and wherein N1 bits are assigned to indicate a primitive compositive AWV and N2 bits are assigned to indicate a steering vector, and wherein N1 and N2 are greater than or equal to one and N1+N2 is smaller than or equal to N.

8. The method of claim 6, wherein one or more beam identifiers (IDs) assigned to one or more application beams within a codebook for an application are mapped to a subset of beam indexes of the set of beams.

9. A method for beam switching control, comprising:
sending a C plane message ahead of a starting symbol, wherein the C plane message includes a beam ID, a starting symbol time within a frame for the beam switching, and a number of symbols for beam dwelling;
receiving a U plane message ahead of the starting symbol or sending a U plane message after receiving the symbol, wherein the U plane message includes signal samples, a starting symbol time, and a number of symbols within a frame of a signal;
retrieving the beam ID from the C plane message; and
forwarding the beam ID to a controller for the beam switching based on the starting symbol time the number of symbols for beam dwelling, and wherein the beam switching is based on a primitive AWV table and a steering AWV table, wherein the primitive AWV table includes one or more primitive composite AWVs of one or more corresponding primitive beams, and wherein each primitive beam is selected from a group of beams with similar beam properties, and the steering AWV table includes set of steering vectors for a set of beams, wherein a set of beam composite AWVs for the set of beams are derived by applying corresponding steering vector in the steering AWV table to a primitive composite AWV in the primitive AWV table.

10. The method of claim 9, further comprising:
generating a beam switching pulse time aligned with a transition of the starting symbol for triggering the beam switch.

11. The method of claim 9, further comprising:
storing each beam index in a circular buffer, wherein the circular buffer includes a plurality of entries, each configured to store a beam index; and
advancing to a next beam index in the circular buffer in response to the beam switching pulse.

12. A phased-array antenna module (PAAM) with reduced size of antenna weight vector (AWV) tables, comprising:
an antenna array with a plurality of antenna elements, each including at least one beamforming integrated circuit (BFIC);
a signal combiner or divider; and
a control and synchronization bus,
wherein the at least one BFIC stores a primitive AWV table, which includes one or more primitive composite AWVs of one or more corresponding primitive beams, and wherein each primitive beam is selected from a group of beams with similar beam properties, and a beam steering AWV table with a set of steering vectors for a set of beams, wherein a set of beam composite AWVs for the set of beams are derived by applying corresponding steering vector in the beam steering AWV table to a primitive composite AWV in the primitive AWV table.

13. The PAAM of claim 12, wherein the primitive AWV table and the beam steering AWV table are generated by grouping the set of beams into different groups based on beam properties comprising a beam strength, a beam shape and a beam sidelobe.

14. The PAAM of claim 12, wherein the primitive AWV table and the beam steering AWV table are generated based on one or more criteria comprising: a primitive beam is selected such that a derived beam is generated based on the primitive beam and a corresponding steering vector to retain similar beam properties, a steering vector is selected such that a derived beam is generated a predefined minimum distortion.

15. The PAAM of claim 12, wherein steering vectors of the beam steering AWV table are used in intrinsic beam or spoiled beam.

16. The PAAM of claim 12, wherein a steering factor for an antenna element at position (nₓ, n_{y}) of the antenna array comprising linear incremental phase shift to steer a beam in x and y direction nₓΔₓ, n_{y}Δ_{y} and an amplitude tapering factor attenuation_{nx,ny}.

17. The PAAM of claim 16, wherein a null steering vector is used to form beam composite AWVs for primitive beams, and wherein the null steering vector has Δₓ=0, Δ_{y}=0, and attenuation_{nx,ny}=0.

18. The PAAM of claim 12, further comprising: assigning a beam index to each beam composite AWV.

19. The PAAM of claim 18, wherein the beam index has multiple N bits, and wherein N1 bits are assigned to indicate a primitive compositive AWV and N2 bits are assigned to indicate a steering vector, and wherein N1 and N2 are greater than or equal to one and N1+N2 is smaller than or equal to N.

20. The PAAM of claim 18, wherein one or more beam identifiers (IDs) assigned to one or more application beams within a codebook for an application are mapped to a subset of beam indexes of the set of beams.
